(19) United States
(12) Patent Application Publication
(10) Pub. No.: US 2020/0373523 A1
(43) Pub. Date: Nov. 26, 2020

(54) PRODUCTION PROCESS FOR BUTTON CELLS AND BUTTON CELL

(71) Applicant: VARTA Microbattery GmbH, Ellwangen Jagst (DE)

(72) Inventors: Ulrich Kohls, Hüttlingen (DE); Bernd Kreidler, Ellwangen (DE)

(21) Appl. No.: 16/856,360

(22) Filed: Apr. 23, 2020

(30) Foreign Application Priority Data
May 23, 2019 (EP) 19176097.4

(51) Int. Cl. H01M 2/02; H01M 10/04

(52) U.S. Cl. CPC H01M 2/0227; H01M 2220/30; H01M 10/0427; H01M 2/0222

(57) ABSTRACT

A button cell includes housing parts each including a circular bottom, a ring-shaped side wall, a circumferential transition region connecting the bottom and the side wall, and an opening edge defining a circular opening, where the circular bottoms and ring-shaped side walls each have an inside facing into the interior space and an outside facing in the opposite direction and the opening peripheries each lie in a plane oriented parallel to the respective bottom, the inside and the outside of the side wall and the opening edge of the first housing part are coated with a solid polymer coating joined by material-to-material bonding to the sides and the opening edge and forms the sealing element, and the polymer coating is thicker at the opening edge than in a region of the side wall which is at a distance from the opening edge.

### TECHNICAL FIELD

This disclosure relates to a process of producing a button cell and a button cell produced by the process.

### BACKGROUND

A particularly well-known example of an electrochemical cell is the button cell. A button cell usually has a cylindrical housing whose height is less than its diameter and encloses a positive electrode and a negative electrode.

The housing of button cells generally consists of two metallic housing parts between which an electrically insulating sealing element is arranged. One of the housing parts is electrically connected to the positive electrode and is accordingly positively poled. The other housing part is electrically connected to the negative electrode and is accordingly negatively poled. The sealing element is intended to prevent electrical contact between the oppositely poled housing parts. In addition, it should counter escape and also intrusion of liquid or moisture from or into the housing.

Various electrochemical systems can be present in the housing. Button cells based on zinc/air, zinc/MnO₂ and nickel/zinc are very widespread. Secondary systems, e.g., systems based on nickel/metal hydride, nickel/cadmium or based on lithium, are also very widespread.

The sealing elements used to produce button cells are classically produced by injection molding, for example, from polyamides. However, the injection molding tools required for this purpose are very expensive. Furthermore, it is very difficult to produce sealing elements having wall thicknesses of 0.1 mm and less by an injection-molding process. The greater the wall thickness of a sealing element, the more volume is taken up by the sealing element and the more greatly does it impair the efficient capacity utilization of a button cell.

The use of a sealing element produced by deep drawing from a film is known from DE 196 47 593 A1. A cup-shaped molding is drawn from a heated film by a drawing die and a shaping punch under reduced pressure. In the bottom region of the molding produced by deep drawing, stamping-out is subsequently carried out by a cutting punch and a cutting sleeve. Depending on the process parameters selected, sealing elements having wall thicknesses of significantly below 0.1 mm can be produced using this process.

A button cell having such a sealing element offers significant advantages in respect of the achievable capacity utilization over button cells having sealing elements made of injection-molded parts. Regardless of this, attempts to achieve ever thinner sealing elements are subjected to limitations for another reason. The thinner the sealing elements used, the more difficult are they to process. Processing requires sufficient mechanical strength. This is often no longer present at thicknesses of <0.1 mm.

Coating button cell housing parts with parylenes, ormocers or polymers in the sealing region is known from EP 2258010 B1. However, the PVD processes described have been found to be very expensive and complicated. In addition, masking was necessary to avoid undesirable coatings. Problems also arose in housing parts which, in contrast to a double-walled edge formed by folding over, as is depicted, for example, in FIGS. 1 and 2 of JP 2002-373711 A, are completely single-walled and have a terminal cut edge. While sealing elements produced by injection molding can readily shield such cut edges, the coatings formed by the coating processes described in EP 2258010 B1 are relatively easily damaged by the cut edge, which led to undesirable gassing effects.

It could therefore be helpful to provide button cells having very thin sealing elements and are improved in respect of the problems described.

### SUMMARY

We provide a process of producing a button cell including a housing having an interior space in which a positive electrode, a negative electrode, and a separator are arranged, wherein the housing includes a cup-shaped, metallic first housing part, a cup-shaped, metallic second housing part, and an electrically insulating sealing element between the housing parts, the housing parts each include a circular bottom, a ring-shaped side wall, a circumferential transition region connecting the bottom and the side wall, and an opening edge defining a circular opening where the circular bottoms and the ring-shaped side walls each have an inside facing into the interior space and an outside facing in an opposite direction and the opening edges each lie in a plane oriented parallel to the respective bottom, the process including coating the inside and outside of the side wall and the opening edge of the first housing part with a liquid polymer precursor, and drying and/or curing the liquid polymer precursor to form a solid polymer coating on the first housing part, wherein the opening edge of the first housing part is perpendicular for at least part of the time or points downward with a deviation of not more than 5° from the vertical direction, and such that the housing is made up of the first housing part and the second housing part, and the polymer coating forms the sealing element.

We also provide a button cell including a housing having an interior space in which a positive electrode, a negative electrode, and a separator are arranged, wherein the housing includes a cup-shaped, metallic first housing part, a cup-shaped, metallic second housing part, and an electrically insulating sealing element between the housing parts, and the housing parts each include a circular bottom, a ring-shaped side wall, a circumferential transition region connecting the bottom and the side wall, and an opening edge defining a circular opening, where the circular bottoms and ring-shaped side walls each have an inside facing into the interior space and an outside facing in the opposite direction and the opening peripheries each lie in a plane oriented parallel to the respective bottom, the inside and the outside of the side wall and the opening edge of the first housing part are coated with a solid polymer coating joined by material-to-material bonding to the sides and the opening edge and forms the sealing element, and the polymer coating is thicker at the opening edge than in a region of the side wall which is at a distance from the opening edge.

### BRIEF DESCRIPTION OF THE DRAWINGS

FIGS. 1A-E are a cross-sectional depiction of an example of a button cell and also the individual steps for the production thereof.

### DETAILED DESCRIPTION

Our button cells can be produced by our process and are characterized by the following features:
a. a housing having an interior space in which

a positive electrode,

a negative electrode, and

a separator are arranged.
b. the housing comprises

a cup-shaped, metallic first housing part,

a cup-shaped, metallic second housing part, and

an electrically insulating sealing element between the housing parts.
c. the housing parts each comprise

a circular bottom,

a ring-shaped side wall,

a circumferential transition region connecting the bottom and the side wall, and

an opening edge defining a circular opening.
d. the bottoms and side wall each have an inside facing into the interior space and an outside facing in the opposite direction and the opening peripheries each lie in a plane oriented parallel to the respective bottom.

The first housing part and the second housing part are preferably made of metallic materials such as nickel-plated steel or metal sheet. Furthermore, trimetal, for example, with the sequence nickel, steel and copper (from the outside inwards), is also particularly suitable.

The circular bottoms of the first housing part and the second housing part are preferably planar or at least essentially planar. Particular preference is given to the bottoms including an angle Θ of 90°±3°, particularly preferably 90°±1°, with the ring-shaped side walls of the housing parts.

The transition regions joining the bottoms and the side walls preferably comprise the parts of the first and second housing parts that lie outside the plane of the bottoms and are not yet part of the respective associated ring-shaped side wall. The transition regions can, independently of one another, be rounded, for example, shoulder-shaped or else can have the form of a sharp edge.

The bottoms of the first housing part and the second housing part are oriented parallel to one another in the button cell. The distance between the outsides of the bottoms defines the height of the button cell.

Preference is given to the ring-shaped side wall of the housing parts being delimited axially on one side by the transition regions to the bottoms and on the other side by the opening edge.

Preferably, the ring-shaped side walls have at least a hollow-cylindrical section or are shaped as a hollow cylinder.

Preferably, the hollow-cylindrical sections and the mutually parallel bottoms dominate the shape of the button cell whose housings accordingly preferably have a cylindrical or at least essentially cylindrical geometry.

During assembly of the button cell, preference is given to the first housing part being pushed with the opening edge at the front into the second housing part until the opening edge rests on the bottom of the second housing part or a support ring. The connecting straight line through the midpoint of the bottom of the second housing part and the center of its circular opening defines the axis (axial direction) along which the first housing part is pushed into the second housing part.

To close the button cell, the edge of the second housing part can be bent over radially inwards after the first housing part has been pushed in. This operation is generally referred to as crimping.

Our button cell is preferably a zinc/air cell, a silver oxide/zinc cell, a zinc/manganese dioxide cell (also known as alkaline manganese cell), a mercury oxide/zinc cell, a nickel/iron cell (Edison accumulator), a nickel/metal hydride cell, a nickel/zinc cell or a nickel/cadmium cell. Accordingly, the negative electrode is preferably a zinc electrode, an iron electrode, a metal hydride electrode or a cadmium electrode. The positive electrode is preferably an air cathode, a silver oxide cathode, a manganese dioxide cathode, a mercury oxide cathode or a nickel oxyhydroxide cathode.

Alternatively, our button cell can also be a lithium cell, i.e., a cell comprising at least one lithium-intercalating electrode.

The separator can be, for example, a porous polymer film or a polymer nonwoven.

The electrodes and the separator are generally impregnated with an aqueous, alkaline electrolyte, for example, with potassium hydroxide solution or sodium hydroxide solution. However, when the button cell is a lithium cell, an organic solvent, usually a mixture of organic carbonates, which is admixed with a lithium electrolyte salt is then usually selected as electrolyte.

The electrodes and the separator are preferably positioned in the housing parts before the second housing part is pushed into the first housing part. In a zinc-air cell, for example, an air cathode and a separator can be laid in the second housing part while a zinc anode in paste form is positioned in the first housing part which is then pushed together with the zinc anode into the second housing part.

Our process of producing button cells having the features a. to d. above comprises the following steps:
e. the inside and outside of the side wall and the opening edge of the first housing part are coated with a liquid polymer precursor,
f. the liquid polymer precursor is dried and/or cured to form a solid polymer coating on the first housing part, where the opening edge of the first housing part is perpendicular for at least part of the time or points downward with a deviation of not more than 5° from the vertical direction (the local direction of the acceleration due to gravity of the earth's gravitational field), and
g. the housing is made up of the first housing part and the second housing part, where the polymer coating forms the sealing element.

Thus, none of the classical injection-molded or film seals described at the outset are used to produce our button cell. Instead, the sealing element is formed from the polymer precursor on the side wall of the first housing part.

The term “polymer precursor” refers to all one-component and multicomponent systems from which solid polymers can be obtained. The polymer precursor can be individual monomers and/or pre-crosslinked monomer, oligomer and polymer components. The polymer precursor can be thermally crosslinkable and/or crosslinkable by radiation. Additives such as crosslinkers, photoinitiators and free-radical initiators can be added thereto. In particular, it can also contain solvents. Furthermore, the polymer precursor can also be a melt of a polymer.

Since, as mentioned at the outset, a sealing element in button cells performs not only a sealing function, but also an insulating function, the polymer precursor is preferably selected so that it has electrically insulating properties after drying and/or curing. In addition, the polymer precursor is, after drying and/or curing, generally preferably chemically inert towards the abovementioned electrolytes, in particular towards aqueous alkaline electrolytes and/or organic electrolytes, in particular those based on carbonate. Precursors for polymers based on epoxide, polyester, polyamide, polyacrylate, polyethylene, polypropylene, polysulfone or polyurethane are particularly preferably used as polymer precursors.

The way in which the step of drying and/or curing is carried out depends on the nature of the polymer precursor. If the polymer precursor is a melt of a polymer, only curing that occurs automatically with progressive cooling of the melt is necessary. If, on the other hand, the polymer precursor is individual monomers and/or precrosslinked monomer, oligomer and polymer components that need further crosslinking and optionally drying to effect curing, the step can be more complicated. In crosslinking by radiation, it is necessary to use, for example, the appropriate radiation sources.

Assembly of the housing preferably comprises the above-described pushing of the first housing part into the second housing part and subsequently closure of the button cell, in particular by the crimping mentioned.

Particularly preferably, the process is characterized by one of the additional steps a. and b. which directly follow:
a. coating of the first housing part is carried out by dipping the first housing part into the liquid polymer precursor.
b. coating of the first housing part is carried out by spraying or brushing the first housing part with the liquid polymer precursor.

Coating as per step a. is particularly advantageous in some examples since masking of regions of the housing part that are not to be coated can be dispensed with. In the simplest example, the first housing part can be dipped with vertically downward-directed opening edge into the polymer precursor. The inside and the outside and also the opening edge of the first housing part are thus wetted with the polymer precursor.

It can be advantageous to coat the inside and the outside of the side wall of the first housing part completely with the liquid polymer precursor. Most preferably, however, only partial coating of the inside and the outside is carried out.

It can be preferred that the inside and the outside of the side wall and the opening edge of the first housing part are coated with the liquid polymer precursor in two or more separate steps. Thus, for example, coating of the first housing part can be carried out by dipping the first housing part into the liquid polymer precursor in a first step. In a second step, the coating can then be strengthened in at least one region by renewed application of the liquid polymer precursor. Between the two steps, there can be a drying and/or curing step. In this way, the thickness of the polymer coating can be locally controlled if required.

Further particularly preferably, the process is characterized by at least one of the additional steps a. to c. which directly follow:
a. a ring-shaped strip composed of the liquid polymer precursor and having a constant width is applied to the inside of the side wall of the first housing part, which strip extends from the opening edge in the direction of the bottom of the first housing part,
b. a ring-shaped strip composed of the liquid polymer precursor and having a constant width is applied to the outside of the side wall of the first housing part, which strip extends from the opening edge in the direction of the bottom of the first housing part,
c. the width of the ring-shaped strip applied to the outside of the side wall of the first housing part exceeds the width of the ring-shaped strip applied to the inside of the side wall of the first housing part.

Particular preference is given to the steps a. and b., in particular the steps a. to c., being realized in combination with one another.

The ring-shaped strips of constant width can be most easily realized by dipping the first housing part as described above with vertically downward-directed opening edge into the liquid polymer precursor. In particular, different strip widths can also be realized on the inside and the outside in this way. Since an air bubble is enclosed in the housing part during vertical immersion and this air bubble cannot be displaced, the polymer precursor cannot completely wet the inside of the side wall even when it is immersed very deeply.

The height of internal and external coating can also be varied by appropriate oblique orientation of the housing part during dipping.

The different height of the resulting coating on the inside and the outside can be associated with great advantages. In general, it is advantageous for the side wall to be coated more or less completely with the polymer precursor on the outside. In these regions, direct contact of the first housing part and the second housing part has to be prevented to avoid an electric short circuit. On the other hand, a coating composed of the polymer precursor on the inside can prevent an electrode from electrically contacting the first housing part. For this reason, it is desirable in some examples for only a thin strip of the side wall inside directly adjoining the opening edge to be coated with the polymer precursor.

In some other examples, the strip is also very wide on the inside to cover regions of the housing part subjected to particularly high mechanical stresses in the production of the housing part by deep drawing. These mechanical stresses can lead to defects on the metal surface of the housing part that in turn can cause gassing and accordingly loss of performance of the cell.

Our button cell that can be produced by the above process is characterized by not only the abovementioned features a. to d. but in particular also by the following additional features:
e. the inside and the outside of the side wall and the opening edge of the first housing part are coated with a solid polymer coating joined by material-to-material bonding to the sides and the edge and forms the sealing element and arranged between the housing parts, and
f. the polymer coating is thicker at the opening edge than in the region of the side wall which is at a distance from the opening edge.

The material-to-material bond results from the polymer coating not being made separately and then mechanically pulled onto the first housing part as in classical sealing elements. Instead, the polymer coating is formed in direct contact with the first housing part, namely on its side wall. The polymer coating preferably cannot be detached from the first housing part without being damaged.

Particularly preferably, the button cell is characterized by at least one of the additional features a. to c. which directly follow:
a. the first housing part is single-walled and has a terminal cut edge as opening edge,
b. the thickness of the solid polymer coating increases in the axial direction towards the cut edge,
c. the solid polymer coating has a droplet-shaped cross section in the region of the opening edge.

Particular preference is given to the features a. and b., in particular the features a. to c., being realized in combination with one another.

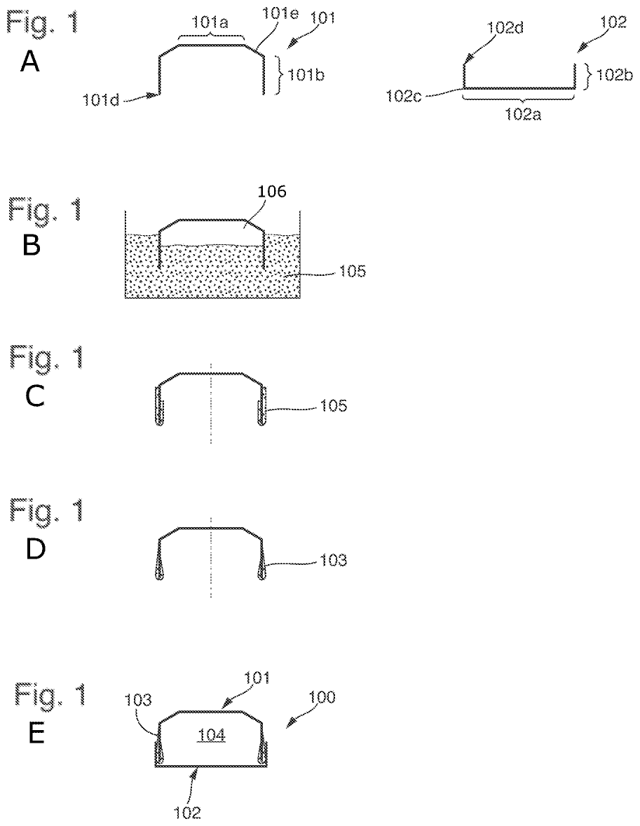

A single-walled construction of the first housing part is intended to mean, in particular, that the first housing part does not have a double-walled edge formed by folding over, like, for instance, the edge of the housing part 3 depicted in FIGS. 1 and 2 of JP 2002-373711 A, that has an axially oriented terminal section folded over through an angle of 180°. Instead, the side wall preferably has a straight course or an at least predominantly straight course in the axial direction through to the opening edge, in particular the opening edge configured as cut edge.

Our process allows production of very thin and at the same time very reliable sealing elements.

It is generally desirable for the inside of the side wall of the first housing part to have a very thin polymer coating to keep the capacity losses associated with the coating as small as possible. On the other hand, the opening edge should ideally be coated with a thicker coating to avoid damage to the polymer coating in the region of the opening edge during assembly of the housing. This cannot be achieved using film seals, for instance as described in DE 196 47 593 A1. They have a uniform thickness. Although sealing elements manufactured by injection molding can be made with different thicknesses in different regions. However, very low thicknesses can be achieved only with difficulty or else make the assembly process difficult.

In contrast, sealing elements having thin walls that are at the same time strengthened in a targeted manner in the region of the opening edge can be produced without problems according to our process. Consequently, the abovementioned single-walled housing parts with a cut edge can also be used.

The above-described orientation of the first housing part during drying and/or curing is of particular importance. The opening edge of the first housing part points downward perpendicularly for at least part of the time or with a deviation of not more than 5° from the vertical direction so that the plane of the opening edge of the first housing part intersects the vertical direction at right angles or with a deviation of <5° from right angles. Particular preference is given to perpendicular orientation. This ensures that the polymer coating has the same thickness at every point on the opening edge. If the first housing part were to be oriented obliquely, a “drip nose” would be formed at the lowest point of the opening edge. The coating would consequently be thicker at this point, which could result in leaks.

The degree to which the vertical orientation of the first housing part can be deviated from depends, inter alia, on the nature of the polymer precursor. The higher the viscosity of the latter, the greater can the deviation from vertical orientation be.

Our button cell is preferably a cylindrical button cell having an underside that is circular at least in one subregion and an upper side that is circular at least in a subregion and a ring-shaped side wall located inbetween. The distance between the upper side and the underside (height of the button cell) is preferably 4 mm to 15 mm. The maximum distance between two points on the side wall of the button cell (diameter of the button cell) is here preferably 5 mm to 25 mm. This is subject to the proviso that the maximum distance between the two points on the side wall is greater than the distance between upper side and the underside.

The nominal capacity of the button cell is generally not more than 2000 mAh. Preferably the nominal capacity is preferably 50 mAh to 1000 mAh, particularly preferably 50 to 800 mAh.

In the European Union, manufacturers' indications concerning the nominal capacities of secondary batteries are strictly regulated. Thus, for instance, indications of nominal capacity of secondary nickel-cadmium batteries have to be based on measurements in accordance with the standards IEC/EN 61951-1 and IEC/EN 60622, indications of nominal capacity of secondary nickel-metal hydride batteries have to be based on measurements in accordance with the standard IEC/EN 61951-2, indications of the nominal capacity of secondary lithium ion batteries have to be based on measurements in accordance with the standard IEC/EN 61960 and indications of the nominal capacity of secondary lead-acid batteries have to be based on measurements in accordance with the standard IEC/EN 61056-1. All indications of nominal capacities in the present application are preferably likewise based on these standards.

Further features, details and preferred aspects can be derived from the appended claims and abstract, the wording of each of which is incorporated by reference into the description, the following description of a preferred example, and also with the aid of the drawing.

To produce the button cell 100, the first housing part 101 and the second housing part 102 are provided (step A). Both housing parts 101 and 102 can, for example, consist of nickel-plated steel sheet or of trimetal. The first housing part 101 has the circular bottom 101a, the ring-shaped side wall 101b, the transition region 101c and the opening edge 101d defining a circular opening. The second housing part 102 has the circular bottom 102a, the ring-shaped side wall 102b, the transition region 102c and the opening edge 102d defining a circular opening. The housing parts 101 and 102 are both single-walled, and their opening peripheries 101d and 102d are both configured as terminal cut edges.

In step B, the housing part 101 is dipped, vertically oriented, into a bath containing the liquid polymer precursor 105. The side wall 101b of the housing part 101 is wetted on the inside and outside with the liquid polymer precursor 105. The wetted regions are each in the form of ring-shaped strips of constant width and each extend from the opening edge 101d in the direction of the bottom 101a of the first housing part 101, with the inside of the side wall 101b not being completely wetted because of air 106 enclosed during dipping. Accordingly, the width of the ring-shaped strip applied to the outside of the side wall 101b of the first housing part 101 exceeds the width of the ring-shaped strip applied to the inside of the side wall 101b of the first housing part 101.

After the housing part 101 has been taken out from the bath containing the liquid polymer precursor 105, the liquid polymer precursor 105 is dried and thermally cured and cured by radiation (step C) to form a solid polymer coating on the first housing part. During the entire drying operation, the opening edge 101d of the first housing part 101 pointed vertically downwards.

The result of drying and curing is shown in D. During drying and curing, part of the liquid polymer precursor 105 applied to the side wall 101b was able to run downwards to the cut edge 101d and accumulate there. Result: the polymer coating 103 was thicker in the region of the opening edge 101d than in regions of the side wall 101b at a distance from the opening edge 101d. It has a droplet-shaped cross section in the region of the cut edge 101d.

In the button cell shown under E, the polymer coating 103 forms the sealing element that electrically insulates the housing parts 101 and 102 from one another and seals the housing. The active components (electrodes, separator, electrolyte) present in the housing are not shown for reasons of clarity.

1. A process of producing a button cell comprising:
a housing having an interior space in which
a positive electrode,
a negative electrode, and
a separator are arranged,
where
the housing comprises
a cup-shaped, metallic first housing part,
a cup-shaped, metallic second housing part, and
an electrically insulating sealing element between the housing parts,
the housing parts each comprise
a circular bottom,
a ring-shaped side wall,
a circumferential transition region connecting the bottom and the side wall, and
an opening edge defining a circular opening
where
the circular bottoms and the ring-shaped side walls each have an inside facing into the interior space and an outside facing in an opposite direction and the opening edges each lie in a plane oriented parallel to the respective bottom,
the process comprises the following steps:
coating the inside and outside of the side wall and the opening edge of the first housing part with a liquid polymer precursor, and
drying and/or curing the liquid polymer precursor to form a solid polymer coating on the first housing part, wherein the opening edge of the first housing part is perpendicular for at least part of the time or points downward with a deviation of not more than 5° from the vertical direction, and
such that the housing is made up of the first housing part and the second housing part, and the polymer coating forms the sealing element.

2. The process according to claim 1 further comprising at least one of:
coating of the first housing part is carried out by dipping the first housing part into the liquid polymer precursor, and
coating of the first housing part is carried out by spraying or brushing the first housing part with the liquid polymer precursor.

3. The process according to claim 1, further comprising at least one of:
a ring-shaped strip composed of the liquid polymer precursor and having a constant width is applied to the inside of the side wall of the first housing part, which strip extends from the opening edge in the direction of the bottom of the first housing part, and
a ring-shaped strip composed of the liquid polymer precursor and having a constant width is applied to the outside of the side wall of the first housing part, which strip extends from the opening edge in the direction of the bottom of the first housing part, and
the width of the ring-shaped strip applied to the outside of the side wall of the first housing part exceeds the width of the ring-shaped strip applied to the inside of the side wall of the first housing part.

4. A button cell comprising:
a housing having an interior space in which
a positive electrode,
a negative electrode, and
a separator are arranged,
wherein
the housing comprises
a cup-shaped, metallic first housing part,
a cup-shaped, metallic second housing part, and
an electrically insulating sealing element between the housing parts,
and
the housing parts each comprise
a circular bottom,
a ring-shaped side wall,
a circumferential transition region connecting the bottom and the side wall, and
an opening edge defining a circular opening,
where
the circular bottoms and ring-shaped side walls each have an inside facing into the interior space and an outside facing in the opposite direction and the opening peripheries each lie in a plane oriented parallel to the respective bottom,
the inside and the outside of the side wall and the opening edge of the first housing part are coated with a solid polymer coating joined by material-to-material bonding to the sides and the opening edge and forms the sealing element,
and
the polymer coating is thicker at the opening edge than in a region of the side wall which is at a distance from the opening edge.

5. The button cell according to claim 4, further comprising at least one of:
the first housing part is single-walled and has a terminal cut edge as opening edge,
the thickness of the solid polymer coating increases in the axial direction towards the cut edge, and
the solid polymer coating has a droplet-shaped cross section in the region of the opening edge.
